(19) United States
(12) Patent Application Publication
(10) Pub. No.: US 2009/0017865 A1
(43) Pub. Date: Jan. 15, 2009

(54) MAKING CALLS USING THE PREFERRED NETWORK

(75) Inventors: Gary Cole, Cary, NC (US); Charles Liu, Chapel Hill, NC (US); Dan Ding, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/777,612

(22) Filed: Jul. 13, 2007

(51) Int. Cl. H04M 1/00

(52) U.S. Cl. 455/552.1

(57) ABSTRACT

A portable electronic device includes call circuitry operable to establish a communication link over a plurality of different communication networks, and a logic circuit operatively coupled to said call circuitry. The logic circuit operative to automatically select a communication network of the plurality of different communication networks prior to establishing the communication link, said selection based on a predefined user preference.

### TECHNICAL FIELD OF THE INVENTION

The present invention relates generally to electronic devices, such as electronic devices for engaging in voice communications. More particularly, the invention relates to a device and method for automatically selecting a preferred network in electronic devices.

### DESCRIPTION OF THE RELATED ART

New features for electronic devices are constantly being developed and brought to market. For example, VoIP functionality is now being offered in electronic devices, wherein voice communications may be directed over an internet connection (e.g., a packet switched network) instead of a conventional cellular circuit-switched network. An advantage of incorporating VoIP functionality in electronic equipment is that it offers an economical alternative to the circuit-switched network.

For example, by directing voice communications over the VoIP network instead of the cellular circuit-switched network, the amount of air-time utilized on the cellular circuit-switched network is decreased. This enables the user to select a service plan with less air-time minutes, thereby reducing the cost of the plan.

### SUMMARY

While the inclusion of VoIP functionality in electronic equipment is advantageous, it does have a drawback. For example, when placing a call, the user must select if the call should be made via VoIP or via conventional wireless networks. This typically involves selecting or entering the number of the party being called, and then specifying the network on which the call is to be made. As is evident, this requires the user to implement an extra step each time a call is being made.

The present invention enables a multi-network enabled electronic device, such as a mobile telephone having the capability of operating over a plurality of different networks, to establish a communication link using a preferred network connection (e.g., VoIP, GSM, etc.), without user intervention. The electronic device can include a network preference entry that may be stored as a user preference, for example. This preference then can be automatically recalled each time a call is made and, if the preferred network is available, it is used to establish the call. If the network is not available, a secondary network may be used to make the call. Further, each contact within a contact list (e.g., a personal contact list of the mobile telephone) may be associated with a different preferred network. For example, contact “A” may have a GSM network as the preferred network, while contact “B” may have a WiFi network as the preferred network.

According to one aspect of the invention, a portable electronic device includes: circuitry operable to establish a communication link over a plurality of different communication networks; and a logic circuit operatively coupled to said call circuitry, said logic circuit operative to automatically select a communication network of the plurality of different communication networks prior to establishing the communication link, said selection based on a predefined user preference.

According to one aspect of the invention, the device further includes a memory, wherein the logic circuit is operative to store in the memory a plurality of different contacts and a plurality of different networks, wherein each of the plurality of different networks is associated with a corresponding one of the plurality of different contacts.

According to one aspect of the invention, the logic circuit is operative to establish the communication link to a contact of the plurality of different contacts over the network associated with the contact.

According to one aspect of the invention, the plurality of difference contacts include at least one of a name, a phone number, or an IP address.

According to one aspect of the invention, the device further includes a display device for providing data to a user, wherein when the user preferred network is unavailable, the logic circuit is operative to output a message via the display indicative of the unavailability.

According to one aspect of the invention, the logic circuit is further operative to output a list of available alternative networks on the display.

According to one aspect of the invention, the logic circuit is further operative to output the selected network on the display.

According to one aspect of the invention, when the preferred network is unavailable, the logic circuit is operative to establish the communication link over a secondary network.

According to one aspect of the invention, the plurality of different networks include at least one of a GSM network, a CDMA network, a WCDMA network, a WiFi network, a WiMax network, a TD-SCDMA network, a MIMO network, or a FLO network.

According to one aspect of the invention, the device further includes a memory, wherein the logic circuit is operative to store in the memory a plurality of different contacts, at least one contact including a plurality of different contact information, wherein when a call is initiated to a contact of the plurality of contacts, contact information is selected that corresponds to the called contact and to an operational mode or setting of the electronic device.

According to one aspect of the invention, a method for using a portable electronic device to establish a communication link over at least one of a plurality of different communication networks includes automatically selecting a communication network of the plurality of different communication networks prior to establishing the communication link, said selection based on a predefined user preference.

According to one aspect of the invention, the method further includes storing in memory a plurality of different contacts and a plurality of different networks, wherein each of the plurality of different networks is associated with a corresponding one of the plurality of different contacts.

According to one aspect of the invention, the method further includes establishing the communication link to a contact of the plurality of different contacts over the network associated with the contact.

According to one aspect of the invention, storing the plurality of different contacts includes storing at least one of a name, a phone number, or an IP address.

According to one aspect of the invention, the method further includes when the user preferred network is unavailable, outputting a message indicating the unavailability.

According to one aspect of the invention, the method further includes outputting a list of available networks.

According to one aspect of the invention, the method further includes outputting the selected network.

According to one aspect of the invention, the method further includes establishing the communication link over a secondary network when the preferred network is unavailable.

According to one aspect of the invention, the method further includes storing in memory a plurality of different contacts, wherein at least one of the plurality of different contacts is associated with a plurality of different contact information; and when a call is placed to a contact, automatically selecting a contact information of the plurality of contact information that corresponds to the contact and to an operational mode or setting of the electronic device.

According to one aspect of the invention, a computer program embodied on a machine readable medium for using a portable electronic device to establish a communication link over at least one of a plurality of different communication networks includes code that automatically selects a communication network of the plurality of different communication networks prior to establishing the communication link, said selection based on a predefined user preference.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4 illustrates an exemplary lookup table that may be used to associate the preferred network with a corresponding contact in accordance with the invention.

FIGS. 5A-5F are exemplary user interfaces for storing network preference data in accordance with the invention.

FIGS. 6-8 are flow charts illustrating steps for implementing an exemplary preferred network function in accordance with the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus, portable gaming devices, portable media devices (video and/or audio), and the like.

In the present application, embodiments of the invention are described primarily in the context of a mobile telephone. However, it will be appreciated that the invention is not intended to be limited to the context of a mobile telephone and may relate to any type of appropriate electronic equipment.

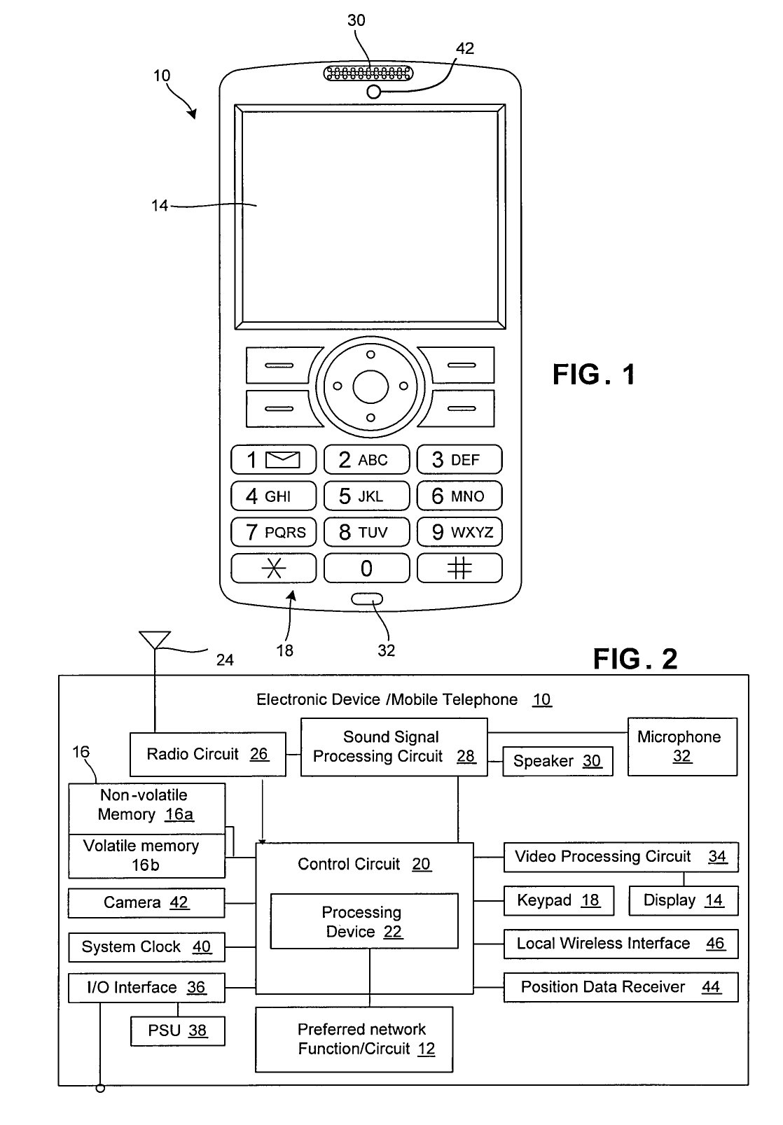

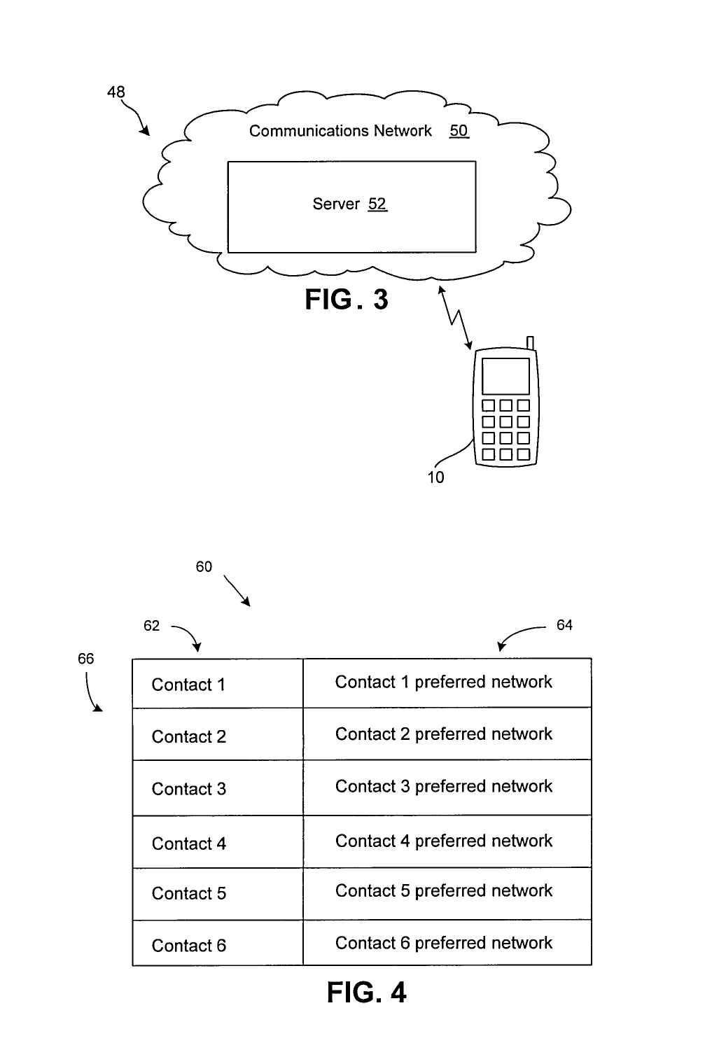

Referring initially to FIGS. 1 and 2, an electronic device 10 is shown. The electronic device 10 includes a preferred network function 12 that is configured to automatically select a preferred network from a plurality of available networks prior to actually placing a call. Additional details and operation of the preferred network function 12 will be described in greater detail below. The preferred network function 12 may be embodied as executable code that is resident in and executed by the electronic device 10. In one embodiment, the preferred network function 12 may be a program stored on a computer or machine readable medium. The preferred network function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a brick or block form factor, although other form factors, such as a “flip-open” form factor (e.g., a “clamshell” housing) or a slide-type form factor (e.g., a “slider” housing) also my be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10.

The memory 16 may include a read only memory area that is implemented using nonvolatile memory 16a, and a random access or system memory area that is implemented using volatile memory 16b. As will be appreciated, nonvolatile memory tends not to lose data storage capability upon loss of power and is typically used to store data, application code, files and so forth. The nonvolatile memory 16a may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 22 during the execution of logical routines. The volatile memory 16b may be a random access memory (RAM). The RAM may be a synchronous dynamic random access memory (SDRAM), for example, but other RAM architectures that utilize memory blocks may be used. Data may be exchanged between the nonvolatile memory 16a and the volatile memory 16b as is conventional. The nonvolatile memory 16a and the volatile memory 16b may be sized as is appropriate for the mobile telephone 10 or other electronic device in which the memory 16 is used.

In addition, the processing device 22 may execute code that implements the preferred network function 12. It will be apparent to a person having ordinary skill in the art of computer programming, and specifically in application programming for mobile telephones or other electronic devices, how to program a mobile telephone 10 to operate and carry out logical functions associated with the preferred network function 12 based on the description herein. Accordingly, details as to specific programming code have been left out for the sake of brevity. Also, while the preferred network function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a preferred network circuit 12 or simply a logic circuit.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures, movies and/or conducting video phone calls. As will be appreciated, the location of the camera on the mobile telephone may be dependent on the type of camera (e.g., a video phone camera may be on the front side of the phone, while a snapshot camera may be on the backside of the phone). Image and/or video files corresponding to the pictures and/or movies may be stored in the memory 16.

The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface, WiFi interface, etc.), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

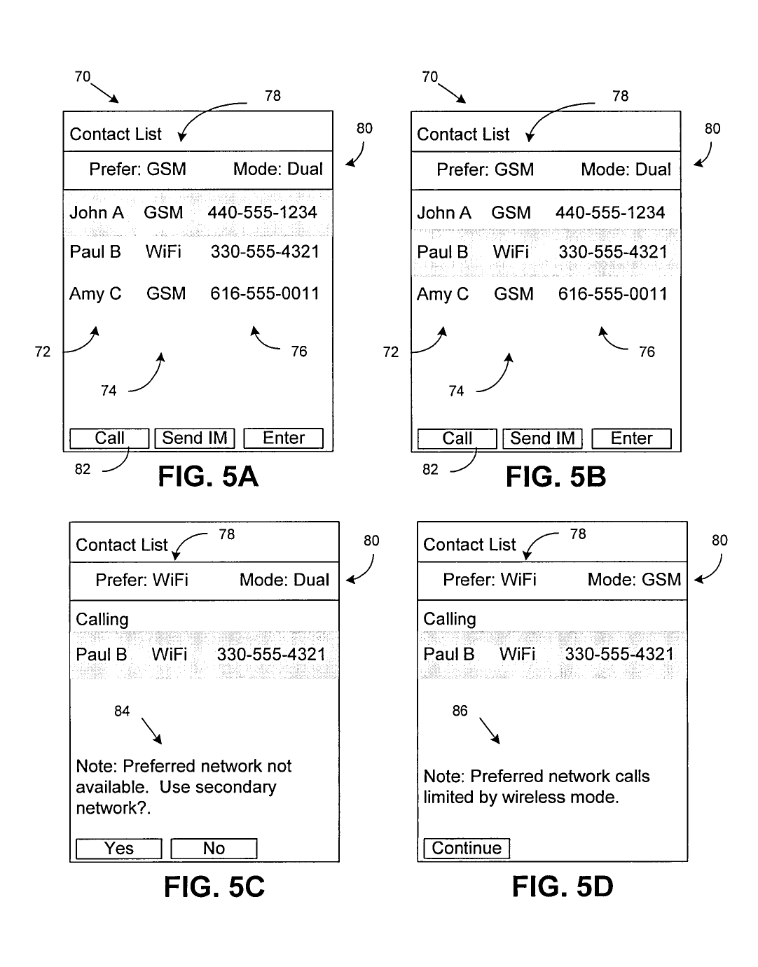

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software.

Moving now to the preferred network function/circuit 12, conventional mobile telephones are capable of establishing a communication link over any one of a number of different communication networks. Non-limiting examples of such networks include GSM (global system mobile communications), CDMA (code division multiple access), FLO (forward link only), MIMO (multiple input, multiple output), TD-SCDMA (time division-synchronous code division multiple access), WCDMA (wideband code division multiple access), WiFi (wireless local area networks), WiMax (Worldwide interoperability for microwave access), etc. If two or more networks are available to the mobile telephone at the same time, there may be certain advantages in establishing the communication link on one of the networks relative to the other networks.

For example, service plans offered by various wireless communication providers are typically based on a number of allocated minutes per time period (e.g., per month). As the number of allocated minutes in the plan increases, so do the fees associated with the plan. If the user exceeds the allocated number of minutes in the specified time period, then a premium may be charged for the additional minutes. Thus, it is desirable to choose a plan that has just enough minutes for the user's needs (i.e., enough minutes to cover all the calls made during the time period, without an excessive amount of “unused” minutes).

As is often the case, however, the number of air-time minutes used from month to month can vary widely. To avoid paying the increased fees associated with exceeding the allocated minutes, users typically agree to a plan that has more minutes than they need. This can result in unused minutes and, which effectively increases the cost.

One way to minimize the use of air-time minutes is to establish a communication link over a different network, such as, for example, a local WiFi network (e.g., a VoIP call), that has little or no fees associate therewith. In this manner, air-time minutes are not charged against the user's air-time plan, and this may make it feasible for the user to change to a plan with less air-time minutes (and thus less cost).

In such situations, however, the user, prior to each call, must select the network on which the call is to be made. This extra step, while not very time consuming, is often not performed by the user. As a result, the call is completed on the service provider's network, thus using some of the allotted air-time minutes.

The preferred network function/circuit 12 of FIG. 2 addresses the above issue. More particularly, the preferred network function/circuit 12 is operative to automatically select a preferred network among a plurality of different networks, without the user having to specify the network prior to each call.

The preferred network may be a general setting (e.g., all calls will be directed through the preferred network, if available), or it may be based on the particular contact (e.g., contact “A” will use network “1”, contact “B” will use network “2”, etc.). Further, if the preferred network is unavailable, which may be the case in areas where service is limited or the signal is weak, then a secondary network may be selected. Prior to utilizing the secondary network, the preferred network function/circuit 12 may provide a message to the user, such as a message informing the user that the preferred network is unavailable, and whether or not the communication should be established on the secondary network. The user then can decide whether or not to complete the call using the secondary network.

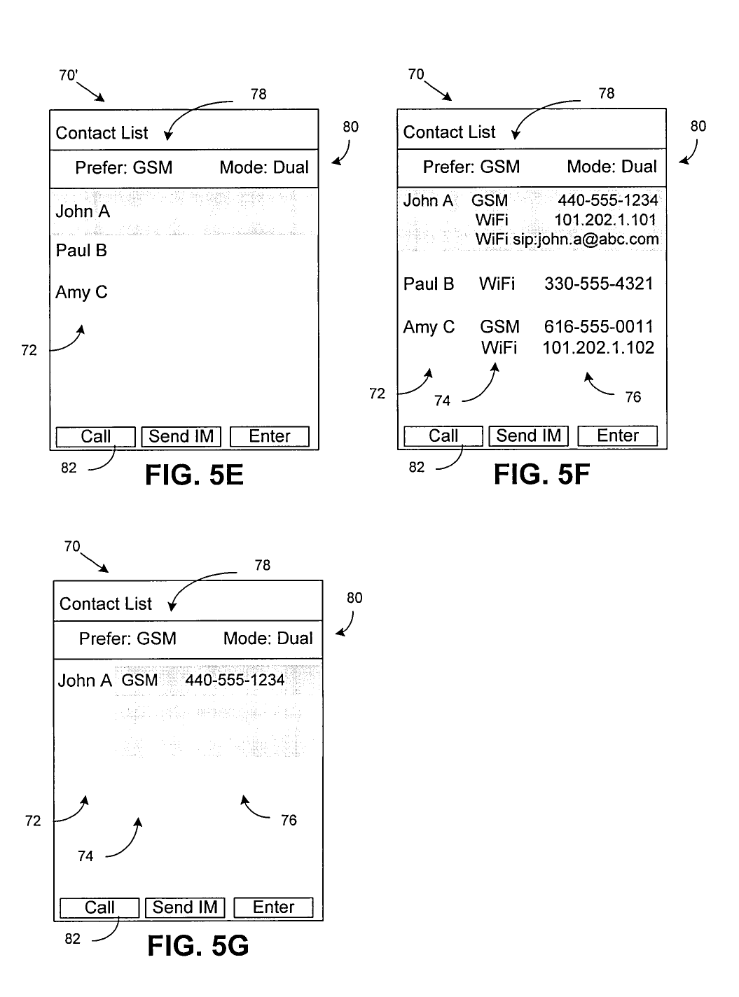

Data utilized by the preferred network function/circuit 12 may be stored in non-volatile memory 16a of the mobile telephone 10 (e.g., as a lookup table or within a database). FIG. 4 illustrates an exemplary lookup table 60, wherein the lookup table includes a contact identifier entry or column 62, and a corresponding preferred network entry or column 64. Although not shown, additional columns for storing other information, such as email addresses, etc., also may be included in the lookup table 60.

The contact identifier entry 62 stores information pertaining to the contact, e.g., the contact name, number, IP address, etc., while the preferred network entry 64 stores information pertaining to a corresponding preferred network for that particular contact. Further, each row 66 of the lookup table 60 corresponds to a different contact. As will be appreciated, the lookup table 60 may include any number of rows, and the illustration of six rows in FIG. 4 is merely exemplary.

Each time a communication is initiated to a contact, the processing device 22 may access the lookup table 60 and search the contact identifier entries 62 for the particular contact. For example, if the user types in the name “Paul B”, the processing device 22 will search the lookup table 60 for entries with the name “Paul B”. If the entry is found, then the preferred network associated with that entry can be retrieved from the lookup table 60, and the call can be placed on the preferred network.

Alternatively, a default network may be defined for the mobile telephone 10, and each time a communication is initiated the default network, if available, is selected. For example, if the default network is set to WiFi, then prior to establishing the communication link, the processing unit 22 checks to see if the WiFi network is available. If it is available, then the communication will be established using the WiFi network. If it is not available, then the user may be prompted whether or not a secondary network should be used to complete the communication. The default network setting may be stored in non-volatile memory 16a and retrieved prior to initiating the communication.

The above also is applicable to the previous example (i.e., to the use of a contact identifier and a corresponding preferred network stored in the lookup table). For example, if a contact is not found in the contact identifier entry 62 of the lookup table 60, then the default network may be selected for establishing the communication link.

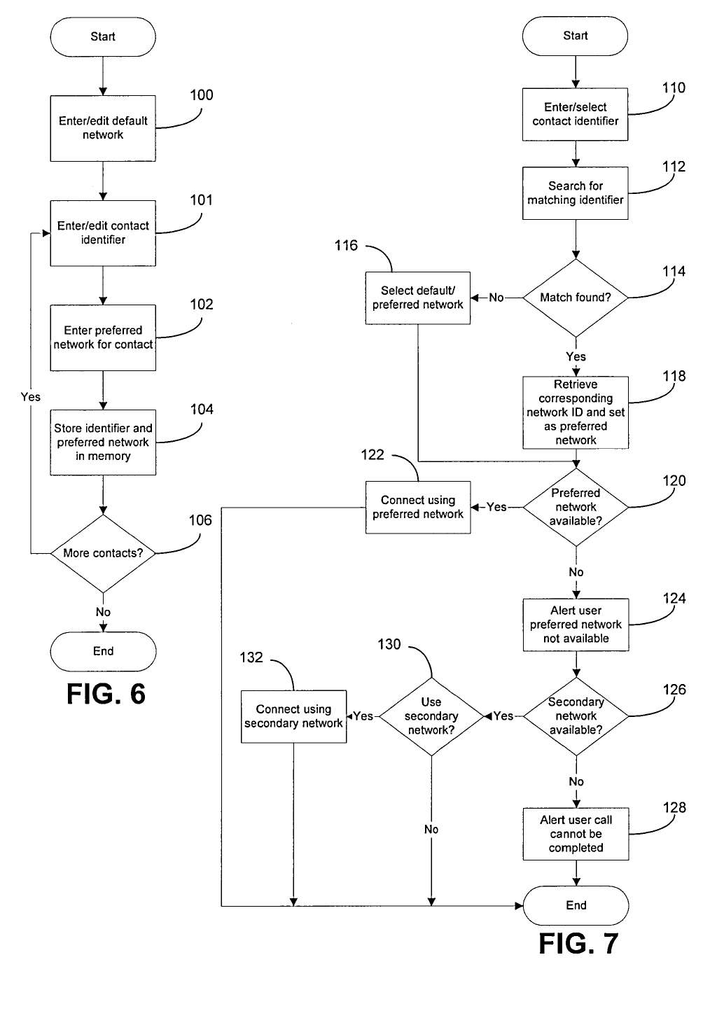

Referring now to FIGS. 5A and 5B, an exemplary detailed contact list 70 (also referred to as a user interface 70) is shown. The detailed contact list 70 includes a plurality of contacts 72, wherein each contact is identified by a name. It will be appreciated, however, that the contacts may be identified by other means, including a phone number, IP address, etc. Each contact 72 of the detailed contact list 70 also includes a corresponding preferred network 74 (e.g., GSM, WiFi, etc.) and contact number 76 (e.g., a phone number, IP address, etc.).

Also provided on the detailed contact list 70 are a default network indicator 78 and an operational mode indicator 80. The default network indicator 78 identifies the default network that will be used when initiating a call (e.g., if a network is not specified by the contact list), while the operational mode indicator 80 identifies on which networks the mobile telephone is presently configured to operate (e.g., GSM, CDMA, etc.). For example, if the default network identifier 78 lists GSM as the default network, then the GSM network will be used to establish communications unless the particular party being contacted is associated with a different network in the detailed contact list 70 (e.g., if Paul B is called, the preferred network will be WiFi instead of the default GSM network).

A contact within the detailed contact list 70 may be selected using conventional means, e.g., using the keypad 18 or touch screen to navigate to the particular contact, wherein the currently selected contact is highlighted. FIG. 5A, for example, shows “John A” selected, while FIG. 5B shows “Paul B” selected. The selected contact may be called by activating the call button 82 on the screen or otherwise pressing the send key on the key pad 18, at which point the call is established using the network corresponding to that contact (if the network is available). If the network is not available, then a notification 84 may be presented to the user, as indicated in FIG. 5C. For example, the notification may alert the user that the network is unavailable, and request input from the user on how to proceed (e.g., use an alternative network or cancel the call).

If the preferred network and the current operational mode of the mobile telephone are in conflict (e.g., preferred or default network does not match or is otherwise not compatible with the operational mode of the phone 10), then an error message may be provided to the user. This is shown in FIG. 5D, wherein the preferred network is set to WiFi (as indicated by the preferred network corresponding to the called party—e.g., the preferred network for the called party Paul B is WiFi), while the operational mode of the phone is set for GSM (as indicated by the operational mode indicator 80). Since the two are in conflict, an error message 86 is provided to the user alerting him of the conflict.

In another embodiment, the default network identifier 78 can be used to automatically select a contact number 76 that will be used to place the call. For example, FIG. 5E illustrates a general contact list 70′, wherein only the contact name is shown. As can be seen in FIG. 5E, the mobile telephone 10 is configured to have a preferred network of GSM, and is operating in dual mode (e.g., both GSM and WiFi, or any two wireless networks in combination, such as, for example, CDMA and WiMaX, GSM and WiMAX, CDMA and WiFi, etc.).

Although not shown in FIG. 5E, each contact 72 of the contact list 70′ may have multiple contact numbers. For example, and with further reference to FIG. 5F, a detailed contact list 70 is shown, wherein the contact “John A” has three different contact numbers (e.g., a GSM number, a WiFi IP address (e.g., a VoIP number), and an email address), the contact “Paul B” has one contact number (e.g., a GSM number) and the contact “Amy C” has two contact numbers (e.g., a GSM number and a WiFi IP address or VoIP number). If the user decides to call John A, he may select John A as described herein (e.g., via navigation keys, entering the name “John A” via the key pad, etc.). Since the mobile telephone 10 has a preferred network setting of GSM, the mobile telephone 10 will automatically select the GSM number for John A, as shown in FIG. 5G, and the call will be placed via GSM, without the user having to specify which of the three contact numbers should be used. Non-selectable numbers (e.g., WiFi numbers in the present example) may be grayed out to indicate they are not available.

Similarly, if the mobile telephone 10 were configured to have a preferred or default network setting of WiFi, then if a call were to be placed to John A., the VoIP number will be automatically selected and the call will be placed via WiFi. Alternatively, if the user intends to send an instant message, then the email address would be selected and the message will be transferred via WiFi.

It is noted that in the above example, the details provided in FIGS. 5F and 5G may be transparent to the user. That is, the user may only interface with the general contact list 70′. The details shown in FIGS. 5F and 5G may be performed by the mobile telephone 10, with or without output to the display 14.

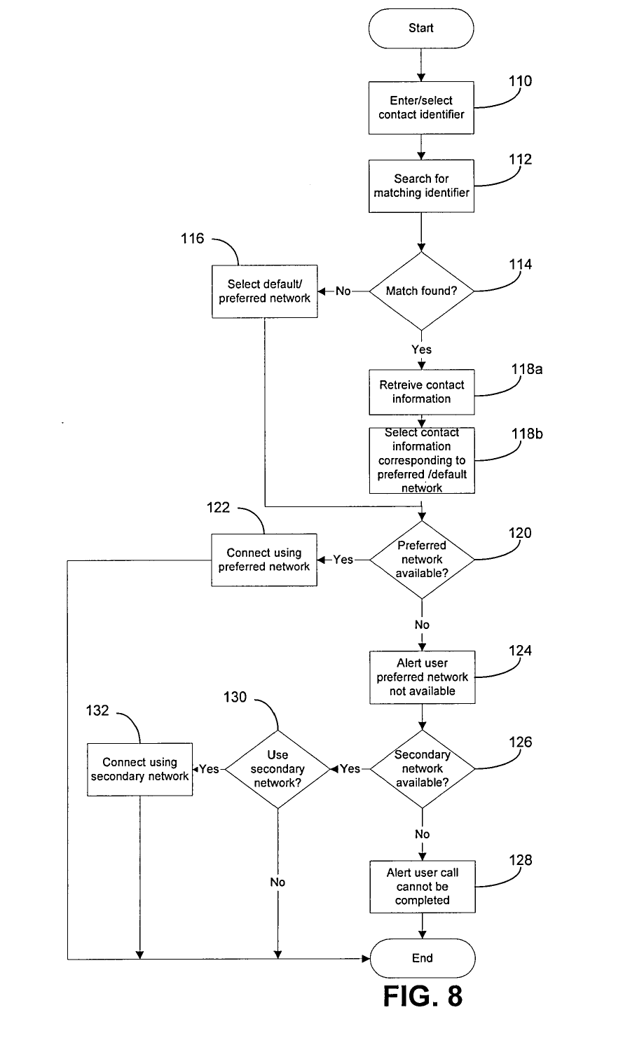

With additional reference to FIGS. 6-8, illustrated are logical operations to implement an exemplary method for storing and retrieving the preferred network used on the mobile telephone 10. The exemplary method may be carried out by executing an embodiment of the preferred network function 12, for example. Thus, the flow charts of FIGS. 6-8 may be thought of as depicting steps of a method carried out by the mobile telephone 10. Although FIGS. 6-8 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

FIG. 6 illustrates exemplary steps for entering a preferred network in the mobile telephone 10. Beginning at block 100, a default network is specified for the mobile telephone. For example, if the user prefers that all communications be established via a WiFi network (if available), then the user may enter WiFi as the preferred or default network. Entry may be via key pad. This entry then can be stored in non-volatile memory 16a for later use (e.g., it can be automatically retrieved prior to completing a call).

At block 101, an identifier for the particular contact is entered or otherwise selected. For example, the name of a contact may be entered into the mobile phone using the keypad 18 (e.g., pressing the keys corresponding to the contact name, number, etc. and then pressing an enter key or the like). Alternatively, if the contact identifier already exists within the phone (e.g., it is already defined in the contact list 70), then the contact may be selected using the key pad 18 (e.g., by using up/down arrow keys to index to the desired entry in the contact list or by pressing keys corresponding to the first few characters of the contact identifier). Once the identifier is entered or otherwise selected, it may be temporarily stored in volatile memory 16b for later use.

At block 102 a preferred network is entered or selected, wherein the preferred network corresponds to the contact identifier. The preferred network may be entered into the mobile telephone 10, for example, by selecting a network from a list of networks, or by entering the name of the preferred network. The entered or selected preferred network also may be temporarily stored in volatile memory 16b for later use.

Next at block 104, the identifier and the corresponding preferred network are retrieved from volatile memory 16b and stored in the lookup table 60, for example, such that the two entries are associated with one another. More specifically, the identifier and preferred network are stored such that if one entry is located within the lookup table 60, the other entry also can be retrieved without performing an additional search. The lookup table 60 can be stored in non-volatile memory 16a. At block 106, it is determined if additional contacts will be entered and/or edited. If additional contacts will be entered/edited, then the method moves back to block 100 and repeats. Otherwise, the method ends.

Moving now to FIG. 7, exemplary steps for retrieving and using the preferred network associated with each contact are shown. Beginning at block 110, the identifier of the party to be called is entered or otherwise selected in the mobile telephone. For example, and similar to block 100 of FIG. 6, the identifier may be entered into the mobile telephone 10 via the key pad 18 (e.g., typing in the name, number, etc. of the contact), or selected from a predefined list (e.g., from the contact list 70). Once the contact identifier is entered, then at blocks 112 and 114 a search is performed within the lookup table 60, wherein the search criterion is the identifier. If a match is not found, then at block 116 the preferred network is set to the default network, and the method moves to block 120. If a match is found, then at block 118 the network associated with the contact identifier is retrieved from the lookup table 60 and set as the preferred network.

At block 120, a determination is made whether or not the preferred network is available. For example, the processing device 22, may instruct the radio circuit 26 to scan the area for available networks. Based on the scan, a list of networks within the range of the mobile telephone 10 can be constructed. If the preferred network is found within the constructed list, then it can be concluded that the preferred network is available. As will be appreciated, there may be additional criteria utilized to determine availability, including signal strength, location of the mobile telephone (e.g., as determined by GPS or the like), etc.

If the preferred network is available, then at block 122, the communication is initiated using the preferred network. However, if the preferred network is not available, then at block 124 a message is provided on the display 14 alerting the user that the preferred network is unavailable.

Nest at block 126, a determination is made whether or not a secondary network is available (e.g., from the list of networks identified during the can above). If a secondary network is not available, then at block 128 the user is alerted that a communication link cannot be established and the method ends. If a secondary network is available, then at block 130 it is determined if the secondary network should be used to establish the communication link (e.g., based on a user input or the like). This may be accomplished, for example, by presenting the user with a list of available secondary networks, and prompting the user to select a secondary network or to terminate the call. If the secondary network is to be used (e.g., the user agrees and/or selects a listed network), then at block 132 the communication link is established via the secondary network. If the secondary network will not be used, then the communication link is not established.

FIG. 8 illustrates exemplary steps for selecting contact information based on the preferred network setting. Many of the steps of FIG. 8 are the same as that of FIG. 7 and, therefore, will not be discussed for sake of brevity. A difference between the method of FIG. 7 and the method of FIG. 8, however, is at blocks 118 (FIG. 7) and 118a-118b (FIG. 8). In particular, instead of retrieving the corresponding network ID and setting the preferred network as shown in FIG. 7, block 118a of FIG. 8 retrieves the contact information for the particular contact from memory 16a. This information can include each contact number associated with that particular contact (e.g., a GSM number, a WiFi or VoIP number, etc.). Then, at block 118b, the contact information corresponding to the default network is selected. For example, if the retrieved contact information includes both a GSM number and a WiFi number, and the mobile telephone 10 is configured for GSM (e.g., the preferred network is set to GSM or the mobile phone is in the GSM operational mode), then the mobile telephone 10 will automatically select the contact number corresponding to the GSM network. The remainder of the method can be carried out as described above with respect to FIG. 7

Accordingly, a method and apparatus for automatically selecting a preferred network has been described. The method and apparatus can reduce the number of air-time minutes utilized on a primary service provider's network, which enables plans with less minutes (and thus less cost) to be selected.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device, comprising:
call circuitry operable to establish a communication link over a plurality of different communication networks; and
a logic circuit operatively coupled to said call circuitry, said logic circuit operative to automatically select a communication network of the plurality of different communication networks prior to establishing the communication link, said selection based on a predefined user preference.

2. The device according to claim 1, further comprising a memory, wherein the logic circuit is operative to store in the memory a plurality of different contacts and a plurality of different networks, wherein each of the plurality of different networks is associated with a corresponding one of the plurality of different contacts.

3. The device according to claim 2, wherein the logic circuit is operative to establish the communication link to a contact of the plurality of different contacts over the network associated with the contact.

4. The device according to claim 2, wherein the plurality of difference contacts include at least one of a name, a phone number, or an IP address.

5. The device according to claim 1, further comprising a display device for providing data to a user, wherein when the user preferred network is unavailable, the logic circuit is operative to output a message via the display indicative of the unavailability.

6. The device according to claim 5, wherein the logic circuit is further operative to output a list of available alternative networks on the display.

7. The device according to claim 5, wherein the logic circuit is further operative to output the selected network on the display.

8. The device according to claim 1, wherein when the preferred network is unavailable, the logic circuit is operative to establish the communication link over a secondary network.

9. The device according to claim 1, wherein the plurality of different networks include at least one of a GSM network, a CDMA network, a WCDMA network, a WiFi network, a WiMax network, a TD-SCDMA network, a MIMO network, or a FLO network.

10. The device according to claim 1, wherein the device is a mobile telephone.

11. The device according to claim 1, further comprising a memory, wherein the logic circuit is operative to store in the memory a plurality of different contacts, at least one contact including a plurality of different contact information, wherein when a call is initiated to a contact of the plurality of contacts, contact information is selected that corresponds to the called contact and to an operational mode or setting of the electronic device.

12. A method for using a portable electronic device to establish a communication link over at least one of a plurality of different communication networks, comprising automatically selecting a communication network of the plurality of different communication networks prior to establishing the communication link, said selection based on a predefined user preference.

13. The method according to claim 12, further comprising storing in memory a plurality of different contacts and a plurality of different networks, wherein each of the plurality of different networks is associated with a corresponding one of the plurality of different contacts.

14. The method according to claim 13, further comprising establishing the communication link to a contact of the plurality of different contacts over the network associated with the contact.

15. The method according to claim 13, wherein storing the plurality of different contacts includes storing at least one of a name, a phone number, or an IP address.

16. The method according to claim 12, further comprising when the user preferred network is unavailable, outputting a message indicating the unavailability.

17. The method according to claim 16, further comprising outputting a list of available networks.

18. The method according to claim 16, further comprising outputting the selected network.

19. The method according to claim 12, further comprising establishing the communication link over a secondary network when the preferred network is unavailable.

20. The method according to claim 12, wherein the plurality of different networks include at least one of a GSM network, a CDMA network, a WCDMA network, a WiFi network, a WiMax network, a TD-SCDMA network, a MIMO network, or a FLO network.

21. The method according to claim 12, further comprising:
storing in memory a plurality of different contacts, wherein at least one of the plurality of different contacts is associated with a plurality of different contact information; and
when a call is placed to a contact, automatically selecting a contact information of the plurality of contact information that corresponds to the contact and to an operational mode or setting of the electronic device.

22. A computer program embodied on a machine readable medium for using a portable electronic device to establish a communication link over at least one of a plurality of different communication networks, comprising code that automatically selects a communication network of the plurality of different communication networks prior to establishing the communication link, said selection based on a predefined user preference.
